(19) United States
(12) Patent Application Publication
(10) Pub. No.: US 2006/0182061 A1
(43) Pub. Date: Aug. 17, 2006

(54) Interworking between wireless WAN and other networks

(75) Inventor: Siamak Naghian, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/108,722

(22) Filed: Apr. 19, 2005

(30) Foreign Application Priority Data
Feb. 17, 2005 (EP) 05 003 459.4

(51) Int. Cl. H04B 7/216

(52) U.S. Cl. 370/331; 370/335; 370/401

(57) ABSTRACT

The present invention relates to method, system and access controller device (50) for providing interworking between a wireless wide area network (WiMAX), and a other network, wherein an access control functionality is provided so as to access an authentication server (64) of the other network, and data of the wide area network is forwarded via the access control functionality to a third network (70). Service control functions of the other network are used to perform common service control for the wide area network and the other network. Thereby, seamless connectivity between the wireless wide area network (WiMAX) and other access networks can be achieved.

### FIELD OF THE INVENTION

The present invention relates to a method, system, and access controller device for providing a wireless wide area network, based on e.g. WiMAX (World-wide Interoperability for Mircowave Access), and for providing interworking with current and future networks, such as a Wideband Code Division Multiple Access (WCDMA) network or any other cellular network.

### BACKGROUND OF THE INVENTION

Recent developments in wireless access technologies coupled with rapid growth in the number of mobile and Internet users have made Wireless Internet to become a reality. It is envisaged that the Wireless Internet phenomenon will most likely fuel the future growth of the communication business. On the other hand, the IEEE 802.16 standard, so-called WiMAX standard, is bringing the first Broadband Wireless Access (BWA) interoperability standard to the markets, helping remove boundaries of the BWA proprietary solutions. The IEEE 802.16 standard, the “Air Interface for Fixed Broadband Wireless Access Systems”, is also known as the IEEE Wireless Metropolitan Area Network (MAN), delivering performance comparable to traditional cable, DSL (Digital Subscriber Line) or T1 offerings. IEEE 802.16 wireless technology provides a flexible, cost-effective, standards-based means of filling existing gaps to broadband coverage, and creating new forms of broadband services not envisioned in a “wired” world.

While many technologies currently available for fixed broadband wireless communication can only provide line of sight (LOS) coverage, the technology behind WiMAX has been optimized to provide excellent non line of sight (NLOS) coverage. WiMAX's advanced technology provides large coverage distances of up to 50 km under LOS conditions and typical cell radii of up to 8 km under NLOS conditions. WIMAX technology has many advantages which allow it to provide NLOS solutions, with essential features such as OFDM (Orthogonal Frequency Division Multiplexing) technology, adaptive modulation and error correction. Furthermore, WiMAX has many optional features, such as ARQ (Automatic Repeat Request), sub-channeling, diversity, and space-time coding that will prove invaluable to operators wishing to provide quality and performance that challenges wireline technology.

Although the IEEE 802.16 standards specify the underlying physical and link layers' function, many networking issues of the access technology remained unsolved. Because WiMAX is primarily considered as a Wide Area Network (WAN), it is essential to develop the networking and interworking concepts that could ensure seamless connectivity between WiMAX and other access networks, in particular Radio Access Networks. It is noted that in the following the term “WAN” is intended to cover also MAN-type of networks.

The main problems with WiMAX access technology is the lack of higher layer procedures and functions when forming a WAN. In particular, the IEEE 802.16 standards don't define how to establish the WAN. For example, the issues of end-to-end security, service provisioning, charging, etc. remain unsolved. In addition, the question of how to form a WAN by using a number of Access Points (AP) is open. Similarly, currently there is neither a well defined end-to-end architecture nor a set of procedures available to cover the interworking between WiMAX access and cellular access. The entire system architecture and the interworking will become necessary to realize the vision of multi-access network that provide services to the end-users by selecting the best technology when considering the requested service.

So far, there are no complete system architecture concepts available for Wireless WAN that could encompass e.g. WiMAX system functional modeling and functional allocation to the network elements through the network starting from the mobile subscriber station (MSS) up to the end point of the network in the back-bone side. Also the issue of interworking with other networks such as cellular networks like 3G technology has not been defined yet.

### SUMMARY OF THE INVENTION

It is therefore an object of the present invention to provide a method and system, by means of which an end-to-end architecture formation of a wireless wide area type of network and its interworking with other networks such as a cellular network can be achieved.

This object is achieved by a method of providing end-to-end system architecture alternatives and interworking paradigms between a wireless wide area network and another network, said method comprising the steps of:
providing an access control functionality for accessing an authentication server of said other network;
routing data of said wide area network via said access control functionality to a third network;
handling the terminal/subscriber mobility by utilizing a hierarchical mobility management scheme, including idle and active mode terminal/subscriber tracking, and handovers both inside the network and also intersystem handovers between the network and the other network, such as a cellular network; and
using service control functions of said other network to perform common service control for said wide area network and said other network.

A set of end-to-end architecture alternative solutions can be provided for handling entire network formation functionalities and corresponding network elements and interfaces.

Furthermore, this object is achieved by a method of providing interworking between a wireless wide area network and another network, said method comprising the steps of:
providing an access control functionality for accessing an IP-based network; and
using wireless access points for connecting terminal devices to said access control functionality.

Moreover, the above object is achieved by a system for providing interworking between a wireless wide area network and another network, said system comprising an access controller for providing access to an authentication server of said other network, wherein data is routed via said access controller to a third network, and wherein service control functions of said other network are used to perform common service control for said wide area network and said other network.

Additionally, the above object is achieved by a system for providing interworking between a wireless wide area network and another network, said system comprising:
an access controller for providing access to an IP-based network; and
wireless access points for connecting terminal devices to said access controller.

In addition, the above object is achieved by an access controller device for providing interworking between a wireless wide area network and another network, said access controller device being arranged to receive data from said wide area network and to access an authentication server of said other network to provide common service control with said other network.

The present invention may optionally be implemented as a computer program product comprising code means for controlling a computer device so as to perform the above method steps when loaded into a memory of said computer device

Accordingly, the present invention provides advantages in that an operator or service provider can now complement other networks' data, e.g. cellular data (e.g. GPRS or UMTS), with wireless WAN (based on e.g. WiMAX) data and can provide common service control with other network systems (e.g. cellular systems), such as SIM authentication and charging. Thereby, mobile operators can add value for enterprises with own virtual private network (VPN) solutions by providing user friendly and secure WiMAX access authentication and accounting, using a common bill, for example.

Additionally, the present invention provides advantages in that an operator or service provider can now complement a WiMAX network with WLAN networks to provide common service control by benefiting from the best of each network e.g. wide coverage of the WiMAX network and low cost and high data rate of the wireless local networks.

Furthermore, evolutionary steps may be implemented to increase the integration level for cost efficient service connectivity, such as common service connectivity with ISN and service based differentiated charging. To enable value added services for enterprises, a common corporate VPN may be established also via the wireless WAN (e.g. WiMAX). Additionally, a wider service coverage can be provided for operator data-centric services.

An access network of the other network may be connected via a GPRS support node to the intelligent service node. Then, the service control functions may comprise service based differentiated charging.

The intelligent service node may be used to provide access to an IP mobility subsystem. A user plane tunnel may then be established to connect at least one access network of the wide area network and the other network to at least one IP-based network. Then, the service control functions may comprise an inter-access handover. In particular, the inter-access handover from an access network of the other network to an access network of the wide area network may be performed by using a relocation signaling of the other network and target parameters may be set based on definitions of an access network protocol of the wide area network. In this case, resources at the wide area network may be allocated based on the target parameters, and a radio link to an access point of the wide area network may be set up.

The inter-access handover may be initiated based on handover criteria comprising at least one of bitrate, end-to-end delay, and degree of mobility. As an example, the relocation signaling may be a RANAP signaling and the access network protocol may be WiMAX Network Application Part (WNAP).

In case the access control functionality is provided in a spin off architecture of the wireless WAN and arranged to provide a direct access to an IP-based network, Ethernet connections may be used for providing connection between the wireless access points and the access control functionality, and/or between the access control functionality and the IP-based network.

Further advantageous developments are defined in the dependent claims.

### BRIEF DESCRIPTION OF THE DRAWINGS

The invention will now be described based on embodiments with reference to the accompanying drawings, in which:

FIG. 1 shows a network architecture according to a first embodiment, in which WiMAX is integrated to the multi-access architecture;

FIG. 2 shows a network architecture according to a second embodiment, in which the WiMAX access becomes a part of multi-access machinery (e.g. authentication, common services, etc.);

FIG. 3 shows a network architecture according to a third embodiment, in which WiMAX is fully integrated to the multi-access machinery (common control and user planes);

FIG. 4 shows a network architecture according to a fourth embodiment as an IP-centric end-to-end architecture of a WiMAX network;

FIG. 5 shows a network architecture according to a fifth embodiment as a fit-to-mobile core network end-to-end architecture of a WiMAX network;

FIG. 6 shows a network architecture for AAA interworking with a cellular network by re-using SIM services;

FIG. 7 shows an example of a network architecture for interworking with a cellular network by re-using charging facilities; and

FIG. 8 shows a schematic processing and signaling diagram of an exemplary procedure of UTRAN-WiMAX handover.

### DESCRIPTION OF THE EMBODIMENTS

In the following, embodiments of the present invention will be described on the basis of different network architectures of different evolutionary stages of an integration of WiMAX access to a multi-access architecture.

In the embodiments, basic interworking method and procedures are described between WiMAX and cellular networks and specifically 3^{rd} generation cellular networks. In particular, interworking functions for 3G cellular networks are proposed for a WiMAX RAN as counterpart access network, where WiMAX is considered as yet another access technology that boosts the complementary access thinking. Additionally, a WiMAX-3G inter-system handover procedure will be defined to deepen the bi-directional interworking.

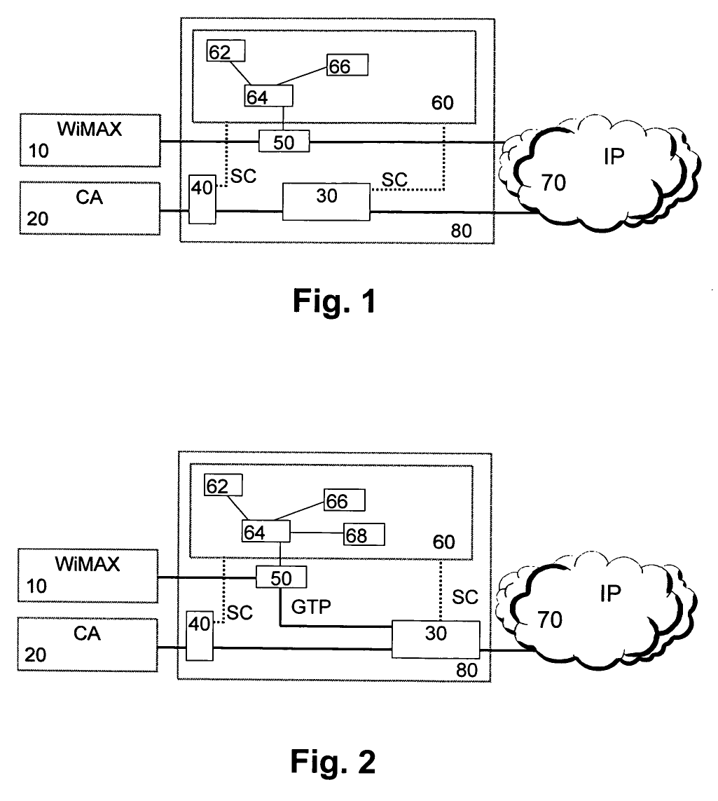

FIG. 1 shows a network architecture according to the first embodiment, in which WiMAX is integrated to the multi-access architecture. Here, WiMAX is considered as a complementary access with minimum level of interworking, e.g. common authentication with the cellular network.

According to FIG. 1, a WiMAX access network 10 and a cellular access network 20 which may be an access network based on GSM (Global System for Mobile communication), GPRS (General Packet Radio Services), EDGE (Enhanced Data rates for GSM Evolution), WCDMA (Wideband Code Division Multiple Access), etc. provide access to a mobile operator core network 80. A core network 80 comprises at least one Serving GPRS Support Node (SGSN) 40 and at least one Intelligent Service Node (ISN) 30 which may be a Gateway GPRS Support Node (GGSN) 30 and which provides access to at least one IP network 70, comprising e.g. an enterprise network, the Internet, or the like, and at least one service provider. The SGSN 40 is connected to the cellular access network 20 and has a switching function and a database for serving a mobile terminal device (i.e. user equipment (UE) in 3G terminology) in its current location for packet switched services. The switching function is used to switch transactions and the database holds a copy of a visiting user's service profile, as well as more precise information on the location of a UE. The GGSN 30 is a gateway switch at a point where the core network 80 is connected to the external IP-base network 70. All incoming and outgoing connections go through the GGSN 30.

Additionally, a service control sub-architecture 60 provides service control to the SGSN 40 and the ISN 30.The service control sub-architecture 60 comprises an authentication server 64 for providing authentication services by which the correct identity of an entity or party is established. The authentication server 64 is connected to a subscriber database or server, e.g. Home Location Register (HLR) 62, for storing subscriber-related data such as user service profiles which may comprise, for example, information on allowed services, forbidden roaming areas, and supplementary service information such as status of call forwarding, the call forwarding numbers etc., and to a charging gateway 66 for charging and billing services. For the purpose of routing incoming transactions to a UE (e.g. calls or messages), the HLR 62 may also store the location of a served UE on the level of the current serving system.

The WiMAX access network 10 can be connected through a WiMAX Access Controller (WAC) 50 to the IP-based network 70, while the WAC 50 is additionally connected to the authentication server 64 of the service control sub-architecture 60 of the core network 80. A cellular network operator is therefore enabled to complement cellular data (e.g. GPRS data) with WiMAX data, wherein WiMAX optionally can be employed as a backbone network. Thereby, WiMAX terminals are supported by the complementary access networks and a common service control can be provided with the cellular network.

The WAC 50 may provide centralized intelligence to regulate traffic between the the WiMAX access network 10 and the IP-based network 70. In particular, the WAC 50 regulates access to the IP-based network 70 by authenticating and authorizing users based on a subscription plan.

As an example, the WAC 50 may provide port-based access control. When a user attempts to utilize a network-based application, such as a Web site via a Web browser, the access controller blocks access and redirects the user's browser to a login-in page. The user can then enter their user name and password, and the access controller will authenticate the user via the authentication server 64. The network application could, as an alternative, use digital certificates for authentication purposes. The authentication server 64 provides authentication and authorization information that the WAC 50 uses as a basis to regulate a user's protected access to the IP-based network 70. The user will have authorization to use specific port addresses, such as “port 80” for Internet browsing.

Furthermore, the WAC 50 may provide encryption of data from the client to the server and back, using such security as IPSec (IP Security), a set of protocols developed by the Internet Engineering Task Force (IETF) to support secure exchange of packets at the IP layer, or Point-to-Point Tunneling Protocol (PPTP), a new technology for creating encrypted VPN tunnels. This provides added protection. In order to support roaming from one network to another, The WAC 50 may provide subnet roaming that allows users to roam without needing to re-authenticate with the system. As a result, users can continue utilizing their network applications without interruption. This feature is especially useful for larger installations where access to the network for specific users will span multiple subnets.

Additionally, because users may share bandwidth in the WiMAX access network 10, it may be important to have a mechanism to ensure specific users don't hog the bandwidth. Therefore, the WAC 50 may provide a form of bandwidth management through the assignment of user profiles based on required quality of service levels. A profile specifies the types of services (e.g., Web browsing, video streaming, etc.) and throughput limit. For example, an unsubscribed visitor could classify as fitting a “visitor” profile, which may only allow access to information related to the local hotspot and online subscription Websites. A subscriber, however, could have a different role that allows them to have access to the Internet at a throughput of e.g. 128 Kbps. For users paying a premium, they could have higher throughput access, perhaps 3 Mbps, for fast downloads and access to other higher end applications.

As an alternative and more cost effective solution, the WAC 50 may be implemented by a “smart” access point or only a “thin” access point alone if security is not of major concern and the number of WiMAX users is only limited.

The common service control may cover at least authentication and charging services. Thereby, the operator of the cellular network can add value for enterprises with own virtual private network (VPN) solutions in that user friendly and secure WiMAX access, authentication and accounting are provided, and that a common bill may be used. Service control signaling SC is exchanged between the SGSN 40 and the service control sub-architecture 60 and between the ISN or GGSN 30 and the service control sub-architecture, as indicated by the dotted lines in FIG. 1.

FIG. 2 shows a network architecture according to the second embodiment, in which the WiMAX access becomes a part of a multi-access machinery comprising e.g. authentication, common services, etc. Here, the WiMAX integration level is increased and a common and thus cost efficient service connectivity is provided by connecting the WAC 50 via the ISN 30 to the IP-based network 70. In this case, the WAC 50 may be adapted to establish a tunnel-based connection e.g. through the GPRS domain of the core network 80 to the ISN 30, by using the GPRS Tunneling Protocol (GTP) in order to get access to the IP-based network 70.

In the second embodiment, value added services can be provided for enterprises utilizing their common corporate VPN also via the WiMAX access network 10. Thereby, a wider service coverage for operator data-centric services can be achieved. In the service control sub-architecture 60, at least one additional subscriber directory 68 may be connected to the authentication server 64 for storing subscription data relating to the subscribed services. This architecture allows service based differentiated charging at the charging gateway 66.

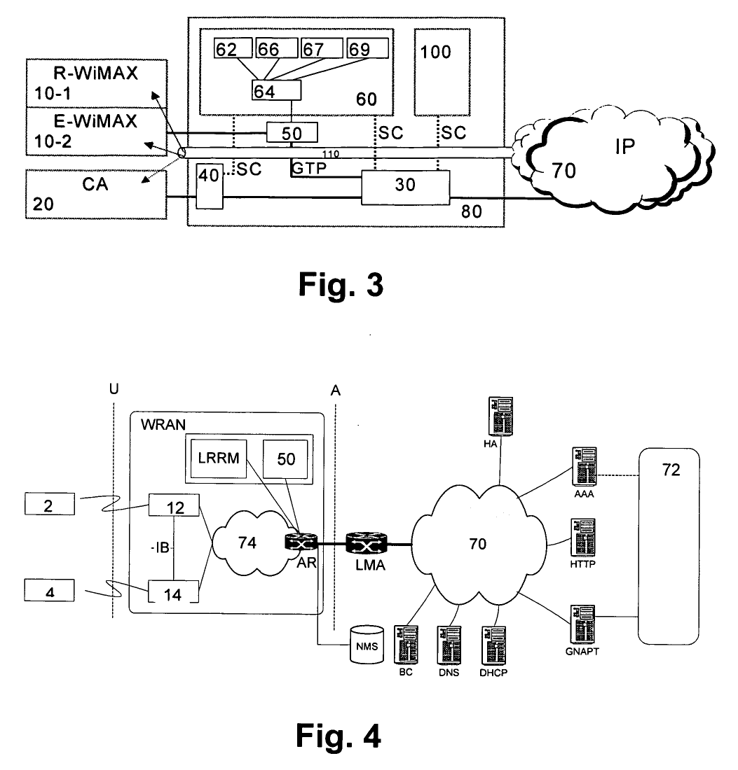

FIG. 3 shows a network architecture according to the third embodiment, in which WiMAX is fully integrated to the multi-access architecture with common control and user planes.

In addition to the features of the second embodiment, the ISN 30 is also connected to an IP Multimedia Subsystem 100 so as to exchange service control signaling SC. Furthermore, the WiMAX access network comprises a residential WiMAX access network 10-1 and an enterprise WiMAX access network 10-2. Due to the fact that common user planes are provide for the WiMAX access network 10 and the cellular access network 20, a user plane tunnel 110 can be established from the access networks to the IP-based network 70 through the core network 80.

The third preferred embodiment enables WiMAX interworking compliant with future cellular standards concerning roaming, terminal support and the like. Session continuity can be achieved by inter-access handovers. Furthermore, consumer services and business services covering voice and data can be provided for residential and enterprise access.

In the third embodiment, the service control sub-architecture 60 additionally comprises e.g. a subscription manager (SM) 67 and an online service controller (OSC) 69.

FIG. 4 shows a network architecture according to the fourth embodiment which is an independent WiMAX end-to-end architecture arranged as an simple and flat IP-centric architecture. Here, a plurality of mobile subscriber stations or WiMAX terminals 2, 4 can be wirelessly connected (e.g. via an IEEE 802.16-2004 and an IEEE 802.16e connection, respectively) to respective access points (APs) or base station devices 12, 14 of a WiMAX RAN (WRAN). The base station devices 12, 14 act as communication hubs for users of the respective WiMAX terminals 2, 4 to connect to an access router (AR), e.g., via an Ethernet 74. The base station devices 12, 14 provide functionalities such as inter base station mobility handling, radio resource (RR) measurement filtering and reporting, power control, network management, scheduling, handover control, ciphering and encryption. The AR provides functionalities such as IP connectivity for subscriber stations (e.g. IP address allocation), Medium Access Control (MAC) address verification, traffic filtering/monitoring for charging purposes, quality of service (QoS) control and mobility control. On WRAN level, a local radio resource management functionality (LRRM) which may be located at the WAC 50 provides functionalities such as handover control, RR optimization, load balancing power control and central RRM assistance. Both LRRM and WAC 50 are connected to the AR. Besides its access control function, the WAC 50 may be responsible for at least one of resource allocation in the WRAN, ciphering, encryption, and integrity checking. The base station devices 12, 14 may be arranged for providing wireless security and for extending the physical range of service a WiMAX user has access to.

In the fourth embodiment, the WAC 50 the comprises a dedicated subscriber database (not shown) for storing authentication and authorization information that the WAC 50 uses as a basis to regulate a WiMAX user's protected access to an IP-based network, such as an IP backbone 70. The IP backbone 70 provides access to at least one of a plurality of network servers 120 comprising a database for subscription information binding for security purposes and mobility handling (e.g. a home agent (HA) for global IP mobility), authentication, authorization and accounting (AAA) server for handling roaming subscribers in external IP networks 72, a HTTP server for providing local application level services for accessing users and facilitating webpage landing to the WiMAX terminals 2, 4, a gateway network address and port translation (GNAPT) server as a gateway toward the external networks 72 and which performs IP network address and port translation and which terminates mobile subscriber station originated and terminated connections, a Dynamic Host Configuration Protocol (DHCP) server for IP stack configuration of mobile subscriber stations, a domain name server (DNS) for mapping Internet domain name addresses into IP addresses, a billing center (BC) for billing related data collection and analysis. The traffic between the Ethernet 74 and the IP backbone 70 is routed through the AR and a local mobility access (LMA) router responsible for inner tier or macro mobility handling, paging and location update of mobile subscriber stations, e.g. the WiMAX terminals 2, 4. This way, a hierarchical Mobile IP based mobility scheme is applied which may consist of three tiers: micro mobility domain which can be limited to the AR, macro mobility tier which could cover a number of ARs or even radio access networks, and global mobility within the realized by HA. Based on this scheme the area under LMA can be assumed as a Routing Area (RA). The RA can be used to handle the idle mode mobility in terms of e.g. paging and location updating. The mobility of the terminal under AR (micro mobility) and between sectors can be hidden from the network elements behind the AR, helping the signaling overhead and shortening the latency . The AR also provides access to a network management system NMS.

The connections between the WAC 50 and the base station devices 12, 14 and/or between the WAC 50 and the IP backbone 70 are thus implemented as Ethernet connections.

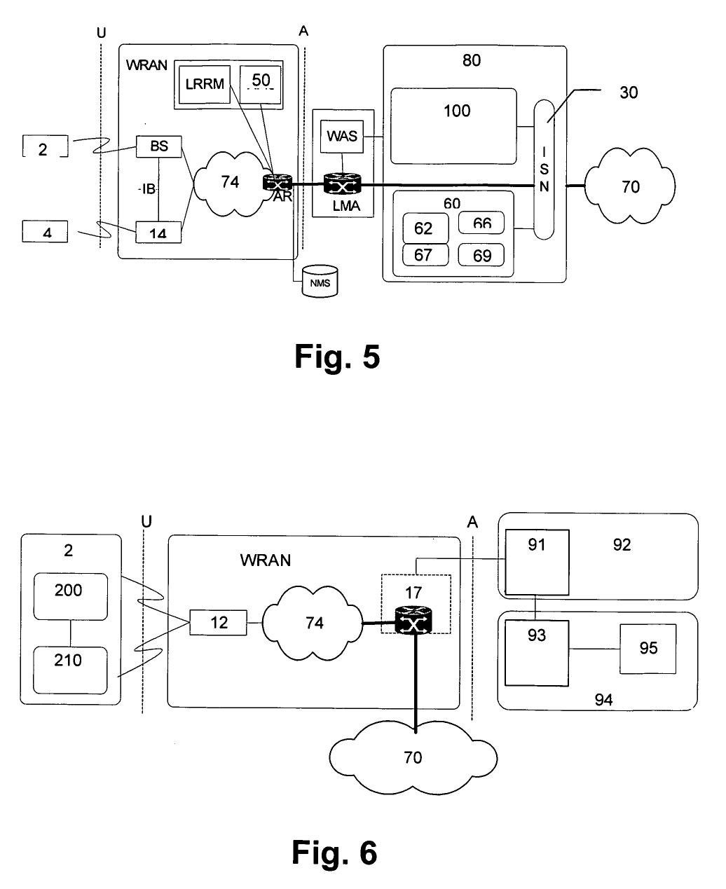

FIG. 5 shows a network architecture according to the fifth embodiment which is an independent WiMAX end-to-end architecture arranged to fit to a mobile core network (CN) 80. Again, the plurality of mobile subscriber stations or WiMAX terminals 2, 4 can be wirelessly connected (e.g. via an IEEE 802.16-2004 and an IEEE 802.16e connection, respectively) to respective access points (APs) or base station devices 12, 14 of a WiMAX RAN (WRAN). For reasons of brevity and simplicity, blocks and functionalities which correspond to those in FIGS. 3 and 4 are not described again here.

In the fifth embodiment, the LMA routes the traffic from the WRAN via an ISN 30 to IP networks 70. The LMA is connected to a WiMAX access server (WAS) responsible for data mapping between the WAC 50 and the CN 80, e.g. for billing purposes, and for authentication signaling to the CN 80 (e.g. the HLR 62 of the service control unit 60 described in connection with the third embodiment). Thereby, WiMAX access can be provided via the mobile CN 80.

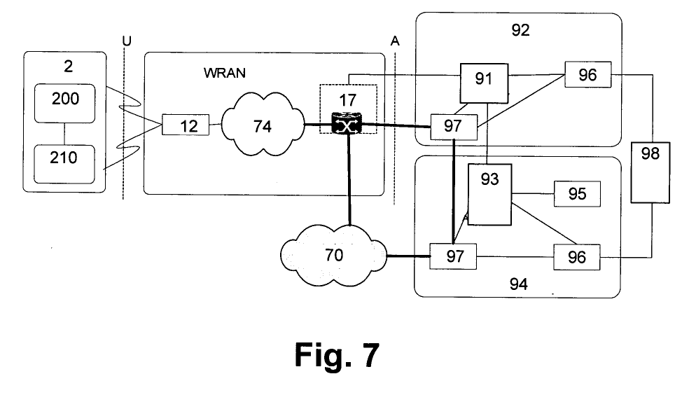

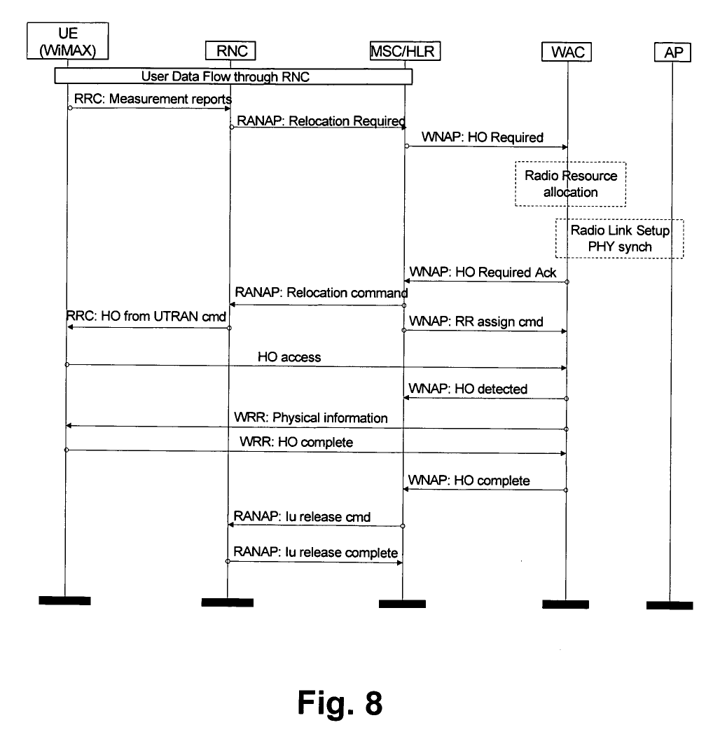

The following FIGS. 6 and 7 show two specific interworking scenarios. In general, interworking may have three levels: interworking in terms of security and authentication, interworking in terms of charging, and interworking in terms of mobility handling, including handover.

FIG. 6 shows a scenario in which a dual mode WiMAX MSS or terminal 2 reuses 3GPP Subscriber Identity Module (SIM) services. The WiMAX terminal comprises a UMTS SIM (USIM) SIM 210 and a WiMAX mode 200. In case of interworking with cellular networks, and when the WiMAX terminal 2 is equipped with both WiMAX mode 210 and USIM SIM 200, the WiMAX terminal 2 is connected by a WAC/AR 17 of the WRAN to a AAA server 93 of e.g. a 3GPP network (as a 3GPP AAA component 94) via AAA proxies 91 of an AAA roaming component 92. The AR/WAC 17 is in charge of security message and protocol conversion between the WIMAX access and the 3GPP network. The AAA proxies 91 communicate with the AAA server 93 by utilizing e.g. DIAMETER or RADIUS protocols and EAP. The AAA server 93 in turn has access to a subscriber data base, e.g. the Home Subscriber Server (HSS) 95. The 3GPP AAA component 94 may also include an EAP functionality. The 3GPP AAA component 94 then verifies the subscriber to use the WiMAX based on the information retrieved from the HSS 95.

FIG. 6 shows a scenario in which the 3GPP charging functionalities are reused for WiMAX.

Once the dual mode terminal 2 has been authorized, it gains access to the network and can send data over the network. So a user session should be established. For this purpose and for gathering the traffic information for WIMAX interworking, a WiMAX gateway (WG) 97 and a WiMAX charging gateway (WCG) 96 are provided as additional elements, and also the interfaces with the AAA proxies 91 and the AAA server 93. The WG 97 or the WAC may collect the data traffic information (statistics on how much data has passed) and deliver it to a 3GPP server which in turn associates this information with the subscriber information and sends the results to the WCG 96 for charging. As the WG 97 has the entire information of the traffic, other charging methods (e.g. IP-Flow-Based Charging) can also be used by utilizing this data and by connecting directly to the WG 97.

In the following, an intersystem handover (HO) procedure will be described based on FIG. 7.

FIG. 7 shows a schematic processing and signaling diagram of an exemplary procedure of such a handover procedure between the WiMAX access and the cellular access in case the cellular access network 20 is a UMTS Terrestrial Radio Access Network (UTRAN).

Inter-system handover between UTRAN and WiMAX can be considered as a special case of an SRNC (Serving Radio Network Controller) Relocation procedure specified in the UTRAN specifications. In particular, the Radio Access Network Application Part (RANAP) protocol is assumed to contain all that information provided by the WiMAX Network Application Part (WNAP) protocol. If the handover is performed from WCDMA to WiMAX, the WCDMA side messages may correspond to the SRNC relocation messages but the contents of those messages vary. When the target is on the WiMAX side, the target ID parameters can be defined based on the WiMAX RAN protocols.

Because the are no similar bearers in WIMAX than in WCDMA, the core network 80 allocates resources instead of bearers. Furthermore, handover criteria could be at least one of bitrate, end-to-end delay (Round Trip Time, RTT), and mobility. WiMAX will most likely have a higher bitrate than cellular and therefore based on the user request a high bitrate connection can be steered to the WiMAX access network 10. Due to its flat and straightforward architecture inherited from the IEEE architecture, WiMAX will most likely provide faster access to the Internet. Finally, the degree on service mobility may vary a lot depending on the service types (e.g. data-centric vs. voice-centric services). Hence, the above parameters can be used as HO criterion when deciding to transfer a connection from the cellular access network 20 to the WiMAX access network 10.

In FIG. 7, an intersystem handover from the cellular access to the WiMAX access is shown. Initially, a user data flow is forwarded from a UE having UTRAN and WiMAX capability through a Radio Network Controller (RNC) of the cellular access network 20 to a Mobile Switching Controller (MSC) of the core network 80. It is noted that the MSC is provided in a circuit-switched domain of the core network 80 and basically corresponds to the SGSN 40 in the packet-switched domain, i.e. GPRS domain.

Based on measurement reports received by the RNC from the UE (e.g. by a Radio Resource Control signaling, RRC), the RNC judges the requirement of intersystem handover based on at least one of the above HO criteria. If intersystem handover is required, the RNC forwards a relocation request (e.g. RANAP Relocation required) to the MSC, which generates and forwards a corresponding handover request message (e.g. WNAP HO Required) to the WAC 50. In response thereto, the WAC 50 allocates radio resources and initiates setup of a wireless link to a WiMAX access point (AP) within the WiMAX access network 10. Then, the WAC 50 issues a handover acknowledgement (e.g. WNAP HO Required Acknowledgement) to the MSC. In response thereto, the MSC forwards a relocation command (e.g. RANAP Relocation) to the RNC, which responsive thereto generates a handover command (e.g. RRC HO from UTRAN). Additionally, the MSC forwards a radio resource assignment command (e.g. WNAP RR assign) to the WAC 50. Having received the handover command, the UE issues with a handover access response to the WAC 50, which generates a handover detection message (e.g. WNAP HO detected) and forwards it to the MSC. Additionally, the WAC 50 transmits physical information in a dedicated message (e.g. WRR Physical information) to the UE, which responds with a handover completion response (e.g. WRR HO complete). In response thereto, the WAC 50 indicates handover completion to the MSC (e.g. WNAP HO complete), which forwards an interface release command (e.g. RANAP lu release) to the RNC. In response thereto, the RNC acknowledges release of the interface (e.g. RANAP lu release complete), to thereby complete the intersystem handover procedure.

It is noted that the proposed solutions according to the above embodiments can be implemented in software modules at the relevant network elements. End-to-end architecture, interworking and inter-system handovers can be implemented incrementally. In the first phase, the interworking components may be easier to implement.

It is further noted that the present invention is not restricted to the above embodiments but can be used in any network environment. While the end-to-end architecture can be applied to any kind of WAN All IP network, the proposed interworking can be applied between any kind of cellular or and a wireless WAN type of network or between another network, e.g. a WAN, and WLAN networks. The embodiments may thus vary within the scope of the attached claims.

1. A method of providing end-to-end system architecture alternatives and interworking paradigms between a wireless wide area network and another network, said method comprising the steps of:
a) providing an access control functionality for accessing an authentication server of said other network;
b) routing data of said wide area network via said access control functionality to a third network;
c) handling terminal or subscriber mobility by utilizing a hierarchical mobility management scheme, including at least one of idle and active mode terminal or subscriber tracking, and handovers both inside the wide area network and intersystem handovers between the wide area network and the other network; and
d) using service control functions of said other network to perform common service control for said wide area network and said other network.

2. The method according to claim 1, wherein said service control functions comprise at least one of SIM authentication and charging.

3. The method according to claim 1, further comprising the step of using said access control functionality to provide access to an intelligent service node.

4. The method according to claim 2, further comprising the step of connecting an access network of said other network via a GPRS support node to said intelligent service node.

5. The method according to claim 4, wherein said service control functions comprise service based differentiated charging.

6. The method according to claim 4, further comprising the steps of using said intelligent service node to provide access to an IP mobility subsystem, and establishing a user plane tunnel to connect at least one access network of said wide area network and said other network to at least one IP-based network.

7. The method according to claim 6, wherein said service control functions comprise an inter-access handover.

8. The method according to claim 7, wherein the inter-access handover from the access network of said other network to an access network of said wide area network is performed by using a relocation signaling of said other network and setting target parameters based on definitions of an access network protocol of said wide area network.

9. The method according to claim 8, further comprising the step of allocating resources at said wide area network based on said target parameters, and setting up a radio link to an access point of said wide area network.

10. The method according to claim 8, wherein said inter-access handover is initiated based on handover criteria comprising at least one of bitrate, end-to-end delay, and degree of mobility.

11. The method according to claim 8, wherein said relocation signaling is a RANAP signaling and said access network protocol is WiMAX Network Application Part.

12. The method according to claim 1, wherein said wide area network is a WiMAX network.

13. A method of providing interworking between a wireless wide area network and a other network, said method comprising the steps of:
a) providing an access control functionality for accessing an IP-based network; and
b) using wireless access points for connecting terminal devices to said access control functionality.

14. The method according to claim 13, further comprising the step of using Ethernet connections for providing connection between said wireless access points and said access control functionality.

15. The method according to claim 13, further comprising the step of using Ethernet connections for providing connection between said access control functionality and said IP-based network.

16. The method according to claim 13, wherein said wide area network is a WiMAX network.

17. A system for providing interworking between a wireless wide area network and another network, said system comprising an access controller for providing access to an authentication server of said other network, wherein data is routed via said access controller to a third network, and wherein service control functions of said other network are used to perform common service control for said wide area network and said other network.

18. The system according to claim 17, wherein said service control functions comprise at least one of SIM authentication and charging.

19. The system according to claim 17, wherein said access controller is adapted to provide access to an intelligent service node.

20. The system according to claim 19, wherein an access network of said other network is connected via a GPRS support node to said intelligent service node.

21. The system according to claim 20, wherein said service control functions comprise service based differentiated charging.

22. The system according to claim 20, wherein said intelligent service node provides access to an IP mobility subsystem, and a user plane tunnel is established to connect at least one access network of said wide area network and said other network to said third network.

23. The system according to claim 22, wherein said service control functions comprise an inter-access handover.

24. The system according to claim 23, wherein the access network of said other network is arranged to initiate an inter-access handover to an access network of said wide area network by using a relocation signaling and by setting target parameters based on definitions of an access network protocol of said wide area network.

25. The system according to claim 24, wherein said access controller is arranged to allocate resources at said wide area network based on said target parameters.

26. The system according to claim 24, wherein said access network is adapted to initiated said inter-access handover based on handover criteria comprising at least one of bitrate, end-to-end delay, and degree of mobility.

27. The system according to claim 24, wherein said relocation signaling is a RANAP signaling and said access network protocol is WiMAX Network Application Part.

28. The system according to claim 24, wherein said wide area network is a WiMAX network.

29. A system for providing interworking between a wireless wide area network and another network, said system comprising:
a) an access controller for providing access to an IP-based network; and
b) wireless access points for connecting terminal devices to said access controller.

30. The system according to claim 29, further comprising first Ethernet connections for connecting said wireless access points to said access controller.

31. The system according to claim 29, further comprising second Ethernet connections for connecting said access controller to said IP-based network.

32. The system according to claim 29, wherein said wide area network is a WiMAX network.

33. An access controller device for providing interworking between a wireless wide area network and another network, said access controller device being configured to receive data from said wide area network and to access an authentication server of said other network to provide common service control with said other network.

34. The access controller device according to claim 33, wherein said access controller device is configured to receive a handover request signaling from said other network and to perform radio resource allocation and radio link setup to an access point of said wide area network in response to said handover request signaling.

35. The access controller device according to claim 34, wherein said wide area network is a WiMAX network and said handover request signaling is a WiMAX Network Application Part signaling.

36. The access controller device according to claim 33, wherein said access controller device provides Ethernet connectivity to at least one of access points of said wide area network or to at least one IP-based network.

37. A computer program product embodied in a computer-readable medium, the computer program product comprising code means for controlling a computer device when loaded into a memory of said computer device so as to perform the steps of:
a) providing an access control functionality for accessing an authentication server of another network;
b) routing data of a wide area network via said access control functionality to a third network;
c) handling terminal or subscriber mobility by utilizing a hierarchical mobility management scheme, including at least one of idle and active mode terminal or subscriber tracking, and handovers both inside the wide area network and intersystem handovers between the wide area network and the other network; and
d) using service control functions of said other network to perform common service control for said wide area network and said other network.
